(19) United States
(12) Patent Application Publication
(10) Pub. No.: US 2013/0147364 A1
(43) Pub. Date: Jun. 13, 2013

(54) BACKLIGHT UNIT

(71) Applicants: Young-Min PARK, Seoul (KR); Hee-Kwang SONG, Suwon-si (KR); Seok-Hyun NAM, Seoul (KR)

(72) Inventors: Young-Min PARK, Seoul (KR); Hee-Kwang SONG, Suwon-si (KR); Seok-Hyun NAM, Seoul (KR)

(21) Appl. No.: 13/664,078

(22) Filed: Oct. 30, 2012

(30) Foreign Application Priority Data
Dec. 12, 2011 (KR) 10-2011-0132836

(51) Int. Cl. H05B 37/02

(52) U.S. Cl. 315/151; 315/294

(57) ABSTRACT

A back light unit includes a first light source which generates first light in a first wavelength range, a second light source which generates second light in a second wavelength range, and a first wavelength compensating part which adjusts a wavelength of the first light controlling a driving current, which is applied to the first light source.

This application claims priority to Korean Patent Application No. 10-2011-0132836, filed on Dec. 12, 2011, and all the benefits accruing therefrom under 35 U.S.C. §119, the content of which in its entirety is herein incorporated by reference.

### BACKGROUND

(1) Field

Exemplary embodiments of the invention relate to a backlight unit. More particularly, exemplary embodiments of the invention relate to a backlight unit compensating wavelength of generated light.

(2) Description of the Related Art

A liquid crystal display (“LCD”) apparatus typically includes a light source for displaying an image with predetermined brightness since an LCD panel of the LCD apparatus does not generate light by itself. The LCD apparatus includes a light source such as a backlight.

In a conventional LCD apparatus, a cold cathode fluorescent lamp (“CCFL”) might be used for a light source of the backlight. In the CCFL, peak wavelengths are fixed and a noise wavelength exists and color purity is low since the light is generated by a gas discharge.

Recently, a light emitting diode (“LED”) lamp is used for a light source of the backlight instead of the CCFL. The backlight using the LED includes at least two LEDs which are used for light sources. In the backlight using the LED, three or more LEDs for a red color, a green color, a blue color may be used for a white color. The LED for a blue color with a red fluorescent material and the LED for a green color may be used for a white color.

The LCD apparatus including a light source may use a light source that covers the entire wavelength range of the displayed colors to display all colors. When the supplied light does not include a wavelength range of a specific color, the specific color cannot be displayed by the LCD apparatus. Generally, a color coordinate may be used for examining a color producing ability of the supplied light.

The color coordinate is typically displayed as a triangle having three vertices for a red color, a green color and a blue color. When one vertex in the color coordinate is not disposed at a proper position, some color may not be displayed using the provided light.

Generally, when LEDs manufactured for the backlight, only a few LED among the entire manufactured LEDs may produce light that satisfies the color coordinate conditions. Thus, a substantial portion of the manufactured LEDs, which emits light that does not satisfy the color coordinate conditions, may not be used for the backlight.

### SUMMARY

Exemplary embodiments of the invention provide a backlight unit which compensates a wavelength of light of a light source.

According to an exemplary embodiment of the invention, a back light unit includes a first light source which generates first light in a first wavelength range, a second light source which generates second light in a second wavelength range, and a first wavelength compensating part which adjusts a wavelength of the first light controlling a driving current, which is applied to the first light source.

In an exemplary embodiment, the first wavelength compensating part may decrease the wavelength of the first light by increasing the driving current applied to the first light source.

In an exemplary embodiment, a shape of light supplied by the backlight unit after adjusting the first light in a color coordinate may have at least about 97% correspondence with a predetermined color coordinate shape in the color coordinate.

In an exemplary embodiment, the first light source generates green light.

In an exemplary embodiment, the wavelength of the first light may be greater than about 527.5 nanometers (nm).

In an exemplary embodiment, a wavelength of the adjusted first light may be in a range of about 525 nm to about 527.5 nm.

In an exemplary embodiment, the second light source generates magenta light.

In an exemplary embodiment, the backlight unit may further include a first intensity compensating part which adjusts light intensity of the first light by controlling the driving current applied to the first light source.

In an exemplary embodiment, the first intensity compensating part may adjust the light intensity of the first light by adjusting a duty ratio of the driving current applied to the first light source.

In an exemplary embodiment, the first intensity compensating part adjusts the duty ratio of the driving current based on an amount of light increased by the first wavelength compensating part.

In an exemplary embodiment, the backlight unit may further include a second wavelength compensating part which adjusts a wavelength of the second light by controlling a driving current applied to the second light source, and a second intensity compensating part which adjusts light intensity of the second light by compensating a duty ratio of the driving current applied to the second light source.

In an exemplary embodiment, the backlight unit may further include at least one additional light source.

According to another exemplary embodiment of the invention, a backlight unit includes a light source which generates light, a wavelength detecting part which detects a wavelength of the light, a wavelength comparing part which compares a reference wavelength with the wavelength of the light of the light source, and a wavelength compensating part which compensates the wavelength of the light when the wavelength of the light is not substantially identical to the reference wavelength such that the compensated wavelength of the light is substantially identical to the reference wavelength.

In an exemplary embodiment, the wavelength compensating part may reduce the wavelength of the light by increasing a driving current, which is applied to the light source.

In an exemplary embodiment, a shape of the light having the compensated wavelength in a color coordinate may have at least about 97% correspondence with a shape of light having the reference wave length in the color coordinate.

In an exemplary embodiment, the light source generates green light.

In an exemplary embodiment, the wavelength of the light generated by the light source may be greater than about 527.5 nm.

In an exemplary embodiment, the compensated wavelength of the light compensated by the wavelength compensating part may be in a range of about 525 nm to about 527.5 nm.

In an exemplary embodiment, the backlight unit may further include an intensity compensating part which adjusts a duty ratio of a driving current, which is applied to the light source.

In an exemplary embodiment, the intensity compensating part may reduce the duty ratio of the driving current based on an amount of light increased by the wavelength compensating part.

According to exemplary embodiments of the invention, a wavelength of light generated by a light source is adjusted by increasing a driving current, and a backlight unit may include a light source, which generates light out of a color coordinate condition, by compensating the light.

In an exemplary embodiment, increased light intensity due to compensating wavelength of light from a light source is reduced by adjusting a duty ratio of the driving ratio, and a wavelength of light is compensated without increased intensity.

### BRIEF DESCRIPTION OF THE DRAWINGS

The above and other features of the invention will become more apparent by describing in detail exemplary embodiments thereof with reference to the accompanying drawings, in which:

FIG. 1 is a graph illustrating a color coordinate corresponding to an exemplary embodiment of a backlight unit according to the invention;

FIG. 2 is a graph illustrating a compensation of the color coordinate of FIG. 1;

FIG. 3 is a graph of relative intensity versus wavelength (nanometer: nm) corresponding to electrical currents (milliampere: mA) applied to an exemplary embodiment of a light source, illustrating a distribution of relative intensity according to wavelength;

FIG. 4 is a graph of wavelength (nm) versus current (mA), illustrating wavelength change of an exemplary embodiment of a light source according to intensity of electrical current;

FIG. 5 is a graph of relative intensity versus wave length (nm), illustrating a distribution of intensity of an exemplary embodiment of a light source according to intensity of electrical current;

FIG. 6 is a graph of distribution ratio versus wavelength (nm), illustrating distribution of light sources according to wavelength of lights generated by the light sources;

FIG. 7 is a block diagram illustrating an exemplary embodiment of a backlight unit according to the invention;

FIG. 8 is a graph of relative intensity versus wavelength (nm), illustrating wavelength compensation of the light from the backlight unit in FIG. 7;

FIG. 9 is a graph of relative intensity versus wavelength (nm), illustrating color coordinate compensation of the light from the backlight unit in FIG. 7; and

FIG. 10 is a block diagram illustrating an alternative exemplary embodiment of a backlight unit according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in further detail with reference to the accompanying drawings.

FIG. 1 is a graph illustrating a color coordinates of an exemplary embodiment of a backlight unit according to the invention.

Referring to FIG. 1, light of an exemplary embodiment of a backlight unit is illustrated as a shape, e.g., a triangle having three vertices, which correspond to a red color R, a green color G and a blue color B, respectively. In an exemplary embodiment, the backlight unit includes at least three light sources. In an exemplary embodiment, the backlight unit includes a blue light source having a red fluorescent and a green light source. In an exemplary embodiment, where two light sources are used, three color components are used for producing a white color light. For convenience of description, two light sources with one fluorescent will be regarded as each independent color light sources.

In the color coordinate, a red light source R, a blue light source B are disposed at each of two vertices of the triangle, and a green light source G may be disposed at a first miss point p1, a second miss point p2 or a matching point s1. In the color coordinate, the triangle formed by the two vertices corresponding to the red light source R and the blue light source B and the matching point s1 may be referred to as a predetermined color coordinate triangle. In the color coordinate, when the green light source G is disposed at the first miss point p1, the triangle formed by three vertices, which correspond to the red light source R, the blue light source B and the green light source G, respectively, does not include an entire portion of the predetermined color coordinate triangle. In an exemplary embodiment, the predetermined color coordinate triangle may include the entire range of possible chromaticities. In an exemplary embodiment, the predetermined color coordinate triangle may correspond to a color gamut. When the green light source is disposed at the first miss point p1, the colors of a first non-displayed area a and a third non-displayed area c may not be displayed. When the green light source is disposed at the second miss point p2, the triangle formed by three vertices, which correspond to the red light source R, the blue light source B and the green light source G, respectively, does not include the entire of the predetermined color coordinate triangle. When the green light source is disposed at the second miss point p2, the colors of a first non-displayed area a and a second non-displayed area b may not be displayed.

When the colors of the first non-displayed area a, the second non-displayed area b or the third non-displayed area c are not displayed by the light sources of the backlight unit, the producing range of the light of the display apparatus is limited. The backlight unit having the light sources having non-displayed areas may not be used for display apparatus. In an exemplary embodiment, the green light source G, which is disposed at the matching point s1 at the color coordinate, may be used for the backlight unit. In an exemplary embodiment, the first miss point p1 or the second miss point p2 of the light source is shifted to the matching point s1 by adjusting a wavelength generating range to use the light source having non-displayed areas.

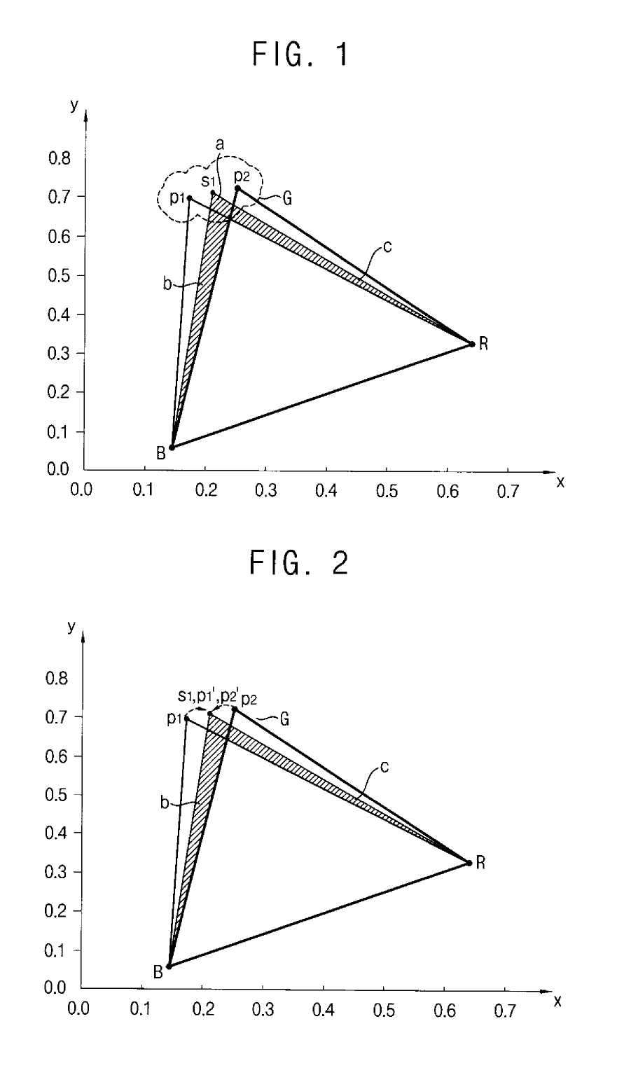

FIG. 2 is a graph illustrating a compensation of the color coordinate of FIG. 1.

Referring to FIG. 2, the green light source G, which is disposed at the first miss point p1, is compensated by a compensating part to be disposed at a first compensating point p1′. The green light source G, which is disposed at the second miss point p2, is compensated by a compensating part to be disposed at a second compensating point p2′. The first compensating point p1 and the second compensating point p2 are substantially coincided with the matching point s1. In an exemplary embodiment, the backlight unit may include the green light source G, which is disposed the first miss point p1 or the second miss point p2 at the color coordinate and satisfies the predetermined color coordinate. The compensated backlight unit can produce light of the second non-displayed area b and the third non-displayed area c.

FIG. 3 is a graph of relative intensity versus wavelength (nanometer: nm) corresponding to electrical currents (milliampere: mA) applied to an exemplary embodiment of a light source, illustrating a distribution of relative intensity according to wavelength.

Referring to FIG. 3, distributions of relative intensity of light according to wavelength when various electrical currents are applied to light sources are shown. The distributions of relative intensity may be shifted to a short-wavelength range area by increasing the electrical current. As the electrical current applied to the light source increases the wavelength of the light generated by the light source decreases. When the supplied electrical current increases, more energy is generated such that the intensity of the light increase. In FIG. 3, five different currents are applied to the light source, e.g., a first supplied electrical current i1, a second supplied electrical current i2, a third supplied electrical current i3, a fourth supplied electrical current i4 and a fifth supplied electrical current i5. In FIG. 3, the first supplied electrical current i1 is about 60 mA, the second supplied electrical current i2 is about 120 mA, the third supplied electrical current i3 is about 180 mA, the fourth supplied electrical current i4 is about 240 mA, and the fifth supplied electrical current i5 is about 300 mA. The intensity distributions according to wavelength of the light generated by the applied electrical current are arranged by a sequence of the intensity distributions according to wavelength of the light generated by the first supplied electrical current i1, the intensity distribution according to wavelength of the light generated by the second supplied electrical current i2, the intensity distribution according to wavelength of the light generated by the third supplied electrical current i3, the intensity distribution according to wavelength of the light generated by the fourth supplied electrical current i4, and the intensity distribution according to wavelength of the light generated by the fifth supplied electrical current i5. The intensity distribution according to wavelength of the light generated by the applied electrical current are shifted toward the short wavelength region, that is the peak wavelength of the intensity distribution according to wavelength of the light generated by the applied electrical current are shifted toward the short wavelength region as the intensity of the applied electrical current increases. In an exemplary embodiment, the light sources having miss point at the color coordinate may be compensated based on the characteristics described above.

When the green light source G has relatively long peak wavelength, the peak wavelength of the green light source G may be shifted to the short wavelength region by applying a higher electrical current. In one exemplary embodiment, for example, a peak wavelength in a range of about 525 nm to about 527.5 nm corresponds to the matching point s1 at the color coordinate, the electrical current greater than 60 mA is applied to the light source having a peak wavelength of 537 nm when about 60 mA electrical current is applied such that the peak wavelength of the light source corresponds to the matching point s1 at the color coordinate. In such an embodiment, the peak wavelength of the light is shifted toward the short wavelength region by applying a greater current.

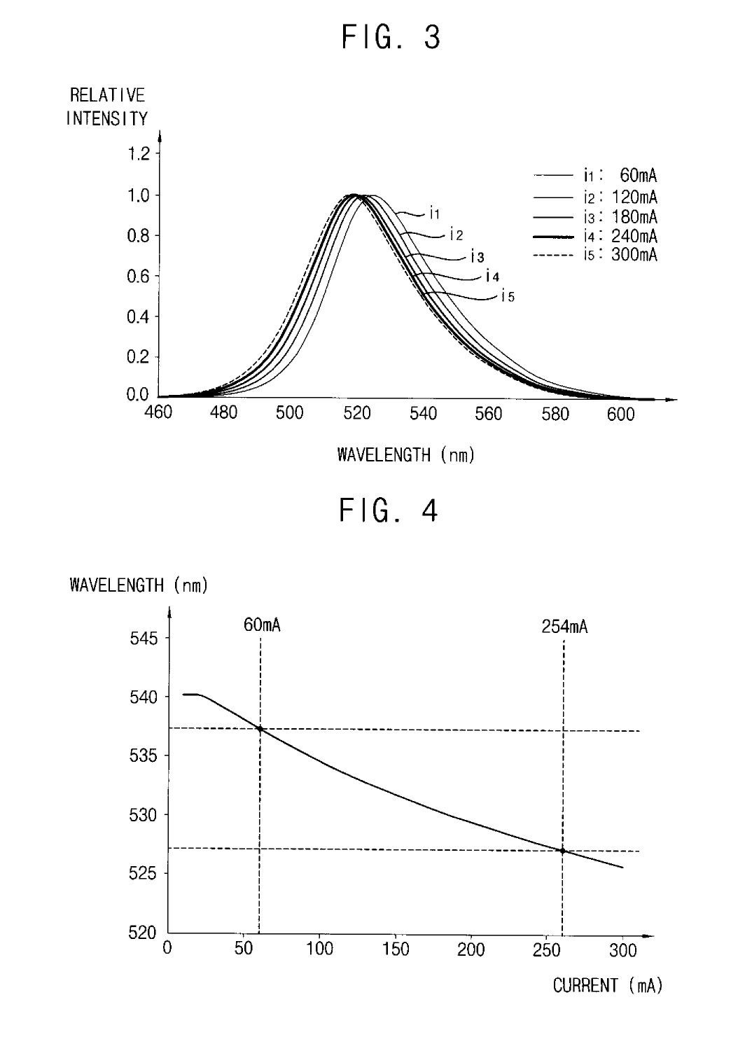

FIG. 4 is a graph of wavelength (nm) versus current (mA) illustrating wavelength change of an exemplary embodiment of a light source according to intensity of electrical current.

Referring to FIG. 4, an exemplary embodiment of a light source may generate light of about 537 nm wavelength when a driving current of about 60 mA is applied thereto. In an exemplary embodiment, the backlight unit may provide the green light of wavelength in a range between about 525.0 nm to about 527.5 nm. In such an embodiment, the driving current of about 254 mA is applied to the light source for compensation. When the driving current of about 254 mA is applied to the light source, the wavelength of the generated light decreases from about 537 nm to about 527.0 nm. In such an embodiment, the generated light may generate light of a wavelength in a range between about 525.0 nm to about 527.5 nm based on the compensation, such that the light source, which may produce light having non-displayed area in the color coordinate, is compensated as shown in FIG. 2.

Table 1, shown below, shows a driving electrical current and a compensated wavelength, which is compensated to be in a range of about 525.0 nm to about 527.5 nm.

TABLE 1

| group | 1 | 2 | 3 | 4 | 5 |
|---|---|---|---|---|---|
| wavelength (nm) | 525.0-527.5 | 527.5-530.0 | 530.0-532.5 | 532.5-535.0 | 535.0-537.5 |
| driving current (mA) | 60 | 97 | 141 | 191 | 254 |
| compensated | 525.0-527.5 | 525.0-527.5 | 525.0-527.5 | 525.0-527.5 | 525.0-527.5 |
| wavelength (nm) | | | | | |

Referring to Table 1, light sources of group 1 are light emitting diodes (“LED”s), which may produce light in the wavelength range of about 525.0 nm to about 527.5 nm by the driving current 60 mA. In Table 1, however, light sources of group 2 generate light of about 527.5 nm to about 530.0 nm wavelength, which may have the non-displayed area in the color coordinate. Thus, the driving current of about 97 mA, which is greater than a normal driving current of about 60 mA, is applied to the light sources of group 2 such that the wavelength of the generated light decreases. The LEDs of group 3, group 4 and group 5 are applied with a greater driving current such that the miss point of the light in the color coordinate is adjusted to be in the matching point.

TABLE 2

| group | 1 | 2 | 3 | 4 | 5 |
|---|---|---|---|---|---|
| wavelength (nm) | 525.0-527.5 | 527.5-530.0 | 530.0-532.5 | 532.5-535.0 | 535.0-537.5 |
| driving current (mA) | 60 | 97 | 141 | 191 | 254 |
| relative intensity of | 1 | 1.67 | 2.35 | 3.18 | 4.23 |
| light | | | | | |

Referring to Table 2, shown above, when the driving current applied to the light source increases, the intensity of the generated light also increases. The light intensity increases based on the intensity of the applied driving current. When the light intensity of a light source corresponding to a specific color increases, only the specific color generated by the light source may be enhanced such that the color image ratio may be distorted. In an exemplary embodiment, the light intensity is compensated simultaneously with the adjustment of the wavelength, as the displayed color at the screen may be different from the original color of the data signal when the color image ratio is distorted. In an exemplary embodiment, the compensation of the light intensity is performed by adjusting a duty ratio of the driving current applied to the light source. In an exemplary embodiment, the amount of the driving current is adjusted by adjusting the duty ratio with respect to maintaining the driving current in a high level, and both of the light intensity and the light wavelength may be compensated at the same time.

TABLE 3

| group | 1 | 2 | 3 | 4 | 5 |
|---|---|---|---|---|---|
| wavelength (nm) | 525.0-527.5 | 527.5-530.0 | 530.0-532.5 | 532.5-535.0 | 535.0-537.5 |
| driving current (mA) | 60 | 97 | 141 | 191 | 254 |
| duty ratio (%) | 100.0 | 61.8 | 42.6 | 31.4 | 23.6 |
| relative intensity of | 1 | 1 | 1 | 1 | 1 |
| light | | | | | |

Referring to Table 3, shown above, the driving current, the duty ratio and the relative intensity of groups 1 to 5, divided by wavelength of the originally produced light, are presented. In an exemplary embodiment, different driving currents are applied to compensate the light sources of each of the groups. In such an embodiment, the intensity of the light increases, as the supplied driving current increase, and the duty ratio of the driving current is adjusted based on the increased intensity of the light.

In the group 1, the LED generates the light, which corresponds to the matching point s1 in FIG. 1. The normal driving current of about 60 mA is applied and the 100% duty ratio is applied. In the groups 2 to 5, the electrical current applied to the LEDs and the duty ratio are compensated.

In the group 2, the driving current of about 97 mA is applied to the LED such that the wavelength is compensated to produce the light corresponding to the matching point s1. When about 97 mA driving current is applied, the light with the wavelength in a range of about 525.0 nm to about 527.5 nm is generated and the generated light corresponds to the matching point s1. In the group 2, the light intensity increases due to the increase of the electrical current such that the displayed color may be distorted by the enhanced specific color of the compensated light source. In the group 2, the relative intensity of the compensated light is compensated to prevent the distortion. When the driving current of about 97 mA with about 61.8% duty ratio is applied, the light intensity is reduced as 61.8% and the duty ratio of another light generated non-compensated light source is maintained such that the distortion by the enhanced specific color of the compensated light source is effectively prevented. Regarding the groups 3 to 5, the light wavelength compensation and the duty ratio compensation are executed in substantially the same manner as described above with respect to the group 2.

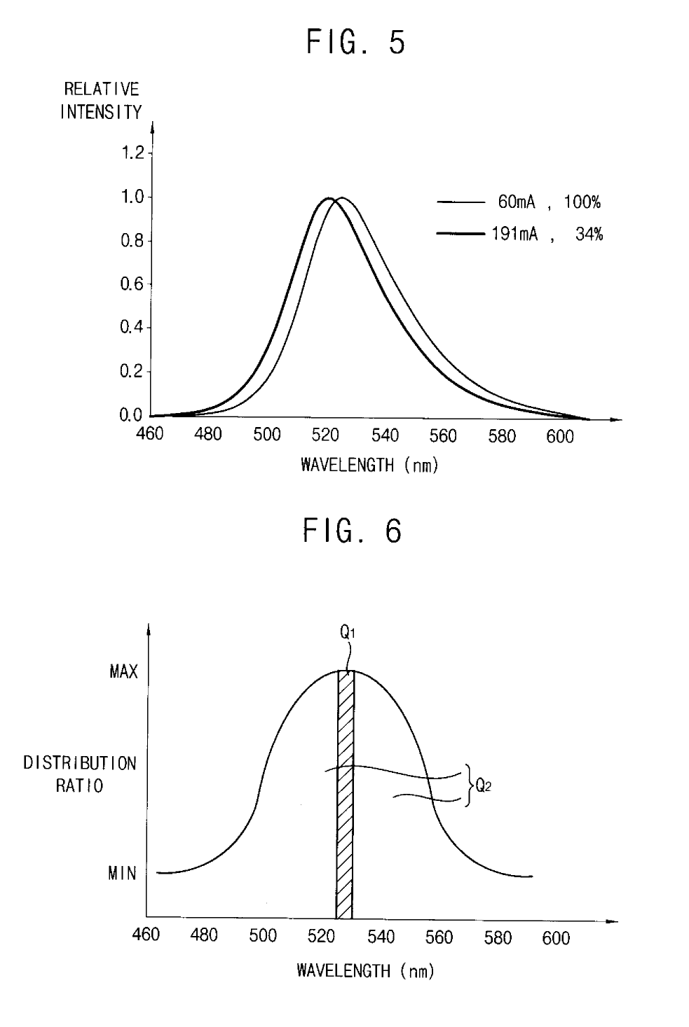

FIG. 5 is a graph of relative intensity versus wave length (nm), illustrating a distribution of intensity of an exemplary embodiment of a light source according to intensity of electrical current.

Referring to FIG. 5, the distributions of intensity according to wavelength of light generated by the LEDs in the group 4 of the Table 3 are illustrated. The LEDs in the group 4 generates the light having the wavelength in a range of about 532.5 nm to about 535.0 nm, which may not correspond to the matching point in FIGS. 1 and 2. In an exemplary embodiment, the driving current of about 191 mA, which is about 3.18 times greater than a normal driving current of about 60 mA, is applied such that the peak wavelength of the generated light is shifted to the wavelength range of about 525.0 nm to about 527.5 nm, which is corresponding to the matching point. In such an embodiment, the duty ratio of the driving current is adjusted to about 30% simultaneously with the wavelength adjustment such that the relative intensity of the light from a light source that receives a current greater than a normal current, e.g., about 60 mA, may be substantially the same as the relative intensity of the light from a light source that receives the normal driving current. In such an embodiment, the wavelength of the light is compensated without changing the light intensity.

FIG. 6 is a graph of distribution ratio versus wavelength (nm) of light source, illustrating distribution of light sources according to wavelength of lights generated by the light sources.

Referring to FIG. 6, when LEDs for the backlight unit are manufactured, the distribution of the light wavelength generated by each of the LEDs. As shown in FIG. 6, the wavelength distribution of the manufactured LEDs may be substantially corresponding to a normal distribution. A valid LED Q1 produces light corresponding to the matching point in the color coordinate, and an invalid LED Q2 produces light not corresponding to the matching point in the color coordinate. Typically, the invalid LED Q2 may not be used for the backlight unit. In an exemplary embodiment, however, the invalid LEDs Q2 may be used for the backlight unit using the wavelength compensation. The compensated invalid light sources may produce light having at least 97% correspondence with the matching point in the color coordinate.

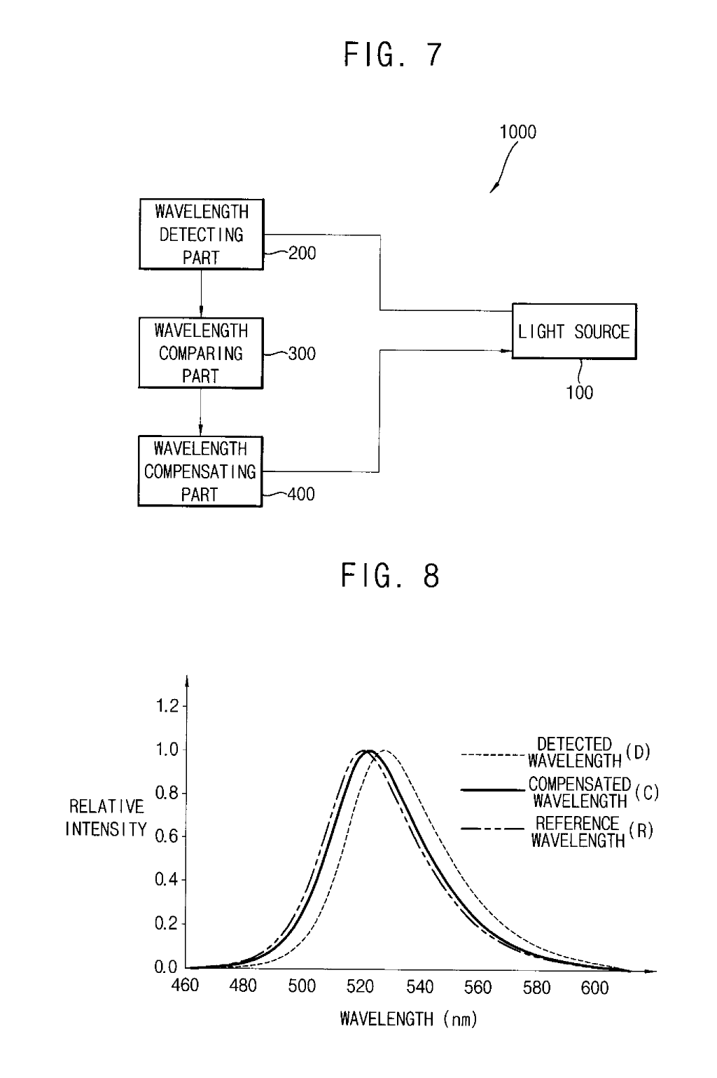

FIG. 7 is a block diagram illustrating an exemplary embodiment of a backlight unit according to the invention.

Referring to FIG. 7, an exemplary embodiment of a backlight unit 1000 includes a light source 100, a wavelength detecting part 200, a wavelength comparing part 300 and a wavelength compensating part 400. The light source 100 generates light of a wavelength. When the light generated by the light source 100 satisfies a predetermined color coordinate condition, e.g., corresponds to the matching point in FIG. 1, the light source 100 is not compensated. In such an embodiment, when the light generated by the light source 100 does not satisfy the predetermined color coordinate condition, the light source 100 is compensated.

The wavelength detecting part 200 detects the wavelength of the light generated by the light source 100. When the light generated by the light source 100 satisfies a condition, the light source 100 is not compensated. When the light generated by the light source 100 does not satisfy the condition, the light source 100 is compensated based on a reference wavelength.

The wavelength comparing part 300 compares the reference wavelength, which corresponds to the predetermined color coordinate condition, with the detected wavelength of the light source 100, which is detected by the wavelength detecting part 200. A degree of the compensation is determined based on the difference between the detected wavelength and the reference wavelength.

The wavelength compensating part 400 compensates the light generated by the light source 100 to satisfy the predetermined color coordinate condition. When the detected wavelength is greater than the reference wavelength, the driving current to be applied to the light source 100 is increased, such that the wavelength of the light generated by the light source 100 decreases. The increased amount of the driving current is determined by the wavelength comparing part 300.

FIG. 8 is a graph of relative intensity versus wavelength (nm), illustrating wavelength compensation of the light from the backlight unit in FIG. 7.

Referring to FIG. 8, the detected wavelength D, which is detected by the wavelength detecting part 200, is greater than the reference wavelength R, which satisfies the predetermined color coordinate condition. In an exemplary embodiment, the light is compensated to have a shorter wavelength to satisfy the predetermined color coordinate condition. In such an embodiment, the wavelength compensating part 400 increases the driving current applied to the light source 100, such that the wavelength of the light generated by the light source 100 is decreased. The compensated wavelength C compensated by the wavelength compensating part 400 is shifted to the shorter wavelength region with respect to the detecting wavelength D, such that the compensated wavelength C may corresponds to the reference wavelength R.

FIG. 9 is a graph of relative intensity versus wavelength (nm), illustrating color coordinate compensation of the light from the backlight unit in FIG. 7.

Referring to FIG. 9, the light source before compensation d, which is detected by the wavelength detecting part 200, does not satisfy the predetermined color coordinate condition, which is corresponding to the reference light source r. In an exemplary embodiment, the wavelength compensating part 400 compensates the light source d, such that the vertex of the light source is compensated to be substantially close to the reference. In such an embodiment, the wavelength of the light generated by the light source 100 is decreased by increasing the driving current, such that the compensated wavelength c is shifted to the reference wavelength r, which satisfies the predetermined color coordinate.

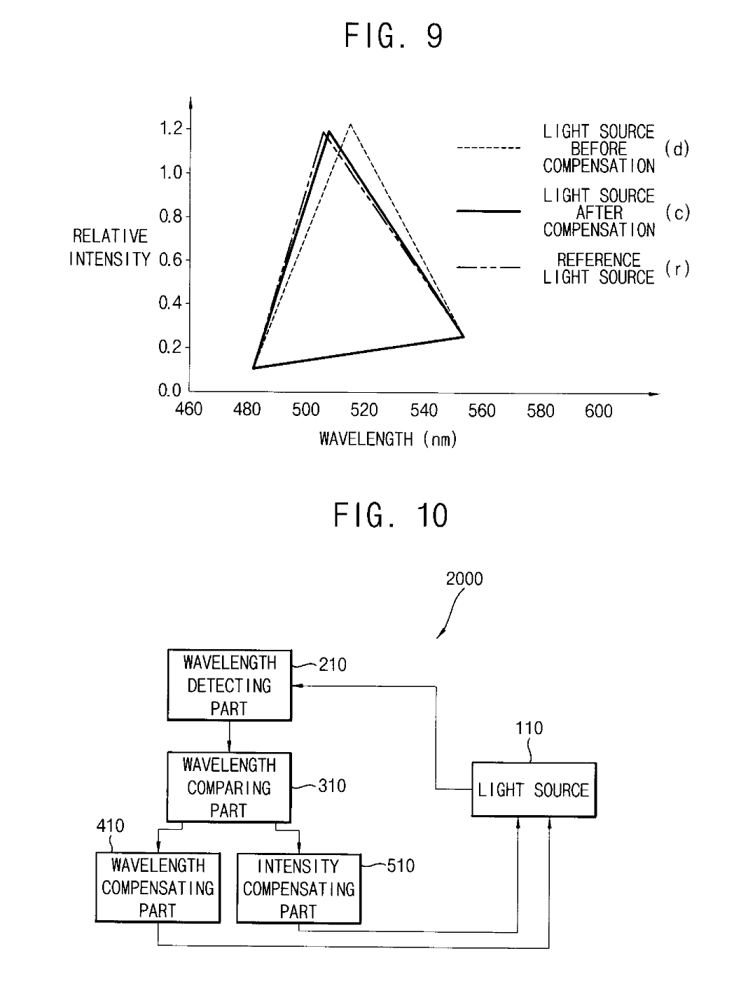

FIG. 10 is a block diagram illustrating an alternative exemplary embodiment of a backlight unit according to the invention.

Referring to FIG. 10, an alternative exemplary embodiment of the backlight unit 2000 includes a light source 110, a wavelength detecting part 210, a wavelength comparing part 310, a wavelength compensating part 410 and an intensity compensating part 510. The backlight unit in FIG. 10 is substantially the same as the backlight unit shown in FIG. 7 except for the intensity compensating part 510, and any repetitive detailed description thereof will hereinafter be omitted or simplified.

In an exemplary embodiment, the intensity compensating part 510 compensates the light intensity increased by the increased driving current. The intensity compensating part 510 may adjust the intensity of the light by adjusting the duty ratio of the driving current applied to the light source 110. In an exemplary embodiment, the intensity compensating part 510 reduces the duty ratio of the driving current based on the increased ratio of the increased current amount or the increased light intensity at the wavelength compensating part 410. In one exemplary embodiment, for example, when the driving current is increased by 25% at the wavelength compensating part 410, the light intensity is increased by about 25%. In such an embodiment, the intensity compensating part 510 reduces the duty ratio of the driving current to 75% to reduce the amount of the driving current by 25%, such that the color distortion, which may be generated by the wavelength compensation of the wavelength compensation part 410, is effectively prevented.

In an exemplary embodiment, a wavelength of light generated by a light source is adjusted by increasing a driving current such that a backlight unit including the light source that generates light out of a predetermined color coordinate condition before adjustment may satisfy the predetermined color coordinate condition.

In an exemplary embodiment, increased light intensity, which might be generated by compensating wavelength, is reduced by adjusting a duty ratio of the driving current to the light source such that a wavelength of light is compensated while intensity thereof is not increased.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A backlight unit comprising:
a first light source which generates first light in a first wavelength range;
a second light source which generates second light in a second wavelength range; and
a first wavelength compensating part which adjusts a wavelength of the first light by controlling a driving current, which is applied to the first light source.

2. The backlight unit of claim 1,
wherein the first wavelength compensating part decreases the wavelength of the first light by increasing the driving current applied to the first light source.

3. The backlight unit of claim 1,
wherein a shape of light supplied by the backlight unit after adjusting the first light in a color coordinate has at least about 97% correspondence with a predetermined color coordinate shape in the color coordinate.

4. The backlight unit of claim 1,
wherein the first light source generates green light.

5. The backlight unit of claim 4,
wherein the wavelength of the first light is greater than about 527.5 nanometers.

6. The backlight unit of claim 1,
wherein a wavelength of the adjusted first light is in a range of about 525 nanometers to about 527.5 nanometers.

7. The backlight unit of claim 1,
wherein the second light source generates magenta light.

8. The backlight unit of claim 1, further comprising:
a first intensity compensating part which adjusts light intensity of the first light by controlling the driving current applied to the first light source.

9. The backlight unit of claim 8,
wherein the first intensity compensating part adjusts the light intensity of the first light by adjusting a duty ratio of the driving current applied to the first light source.

10. The backlight unit of claim 9,
wherein the first intensity compensating part adjusts the duty ratio of the driving current based on an amount of light increased by the first wavelength compensating part.

11. The backlight unit of claim 1, further comprising:
a second wavelength compensating part which adjusts a wavelength of the second light by controlling a driving current, which is applied to the second light source; and
a second intensity compensating part which adjusts light intensity of the second light by compensating a duty ratio of the driving current applied to the second light source.

12. The backlight unit of claim 1, further comprising:
at least one additional light source.

13. A backlight unit comprising:
a light source which generates light;
a wavelength detecting part which detects a wavelength of the light;
a wavelength comparing part which compares a reference wavelength with a wavelength of the light of the light source; and
a wavelength compensating part which compensates the wavelength of the light when the wavelength of the light is not substantially identical to the reference wavelength such that the compensated wavelength of the light is substantially identical to the reference wavelength.

14. The backlight unit of claim 13,
wherein the wavelength compensating part reduces the wavelength of the light by increasing a driving current, which is applied to the light source.

15. The backlight unit of claim 13,
wherein a shape of the light having the compensated wavelength in a color coordinate has at least about 97% correspondence with a shape of light having the reference wavelength in the color coordinate.

16. The backlight unit of claim 13,
wherein the light source generates green light.

17. The backlight unit of claim 16,
wherein the wavelength of the light generated by the light source is greater than about 527.5 nanometers.

18. The backlight unit of claim 16,
wherein the compensated wavelength of the light compensated by the wavelength compensating part is in a range of about 525 nanometers to about 527.5 nanometers.

19. The backlight unit of claim 13, further comprising:
an intensity compensating part which adjusts a duty ratio of a driving current, which is applied to the light source.

20. The backlight unit of claim 19,
wherein the intensity compensating part reduces the duty ratio of the driving current based on an amount of light increased by the wavelength compensating part.
